(19) United States
(12) Patent Application Publication
(10) Pub. No.: US 2026/0185502 A1
(43) Pub. Date: Jul. 2, 2026

(54) TANGENTIAL FLUID TURBINE

(71) Applicant: FNF INNOVATION SH.P.K., Gjilan, Kosovo (AL)

(72) Inventor: Mustafa FEHMI, Gjilan, Kosovo (AL)

(21) Appl. No.: 19/129,957

(22) PCT Filed: Nov. 13, 2023
(86) PCT No.: PCT/EP2023/081593

§ 371 Date: May 14, 2025

(30) Foreign Application Priority Data
Nov. 14, 2022 (EP) 22207181.3

(51) Int. Cl. F03B 17/06; F03B 11/00

(52) U.S. Cl. CPC F03B 17/06; F03B 11/00; F05B 2240/31

(57) ABSTRACT

The present invention relates to a tangential fluid turbine comprising a shaft, a concentric rotor connected to the shaft, blades mounted on the rotor, a fluid inlet channel, a fluid outlet channel, and a circular arc-shaped fluid circulation channel concentric to the shaft and connecting the fluid inlet channel and the fluid outlet channel, the blades of the rotor being displaced therein by the fluid flowing through the fluid circulation channel, whereby the rotary motion of the rotor is brought about, wherein the fluid inlet channel is designed such that the fluid enters the fluid circulation channel in a direction tangential to a circle concentric to the shaft and the fluid outlet channel is designed such that the fluid exits the fluid circulation channel in a direction tangential to a circle concentric to the shaft, and the present invention relates to a method for operating such a tangential fluid turbine, to the use of such a tangential fluid turbine in a motor vehicle, ship, or power plant, and to a motor vehicle, ship, or power plant comprising such a tangential turbine.

The present invention relates to a novel tangential fluid turbine.

Fluid turbines are known, for example turbines differentiated by the inflow direction of the medium as axial types (e.g., Kaplan turbine), tangential types (e.g., Tesla turbine, Pelton turbine), and radial types (e.g., Ljungström turbine, Francis turbine).

The object of the present invention is to further increase the efficiency of conventional fluid turbines and is based on the insight that said object can be achieved when the fluid both enters and exits tangentially to a circle defined by the axis of the shaft as the center point.

The present invention thus provides a fluid turbine comprising a shaft 12, a concentric rotor 13 connected to the shaft 12, blades 5, 5′ mounted on the rotor 13, a fluid inlet channel 1, a fluid outlet channel 2, and a circular arc-shaped fluid circulation channel 11 concentric to the shaft 12 and connecting the fluid inlet channel 1 and the fluid outlet channel 2, the blades 5, 5′of the rotor 13 being displaced therein by the fluid flowing through the fluid circulation channel, whereby the rotary motion of the rotor 13 is brought about,
characterized in that
the fluid inlet channel 1 is designed such that the fluid enters the fluid circulation channel 11 in a direction tangential to a circle concentric to the shaft 12 and the fluid outlet channel 2 is designed such that the fluid exits the fluid circulation channel 11 in a direction tangential to a circle concentric to the shaft 12.

A fluid blocking device 6 is typically present in a fluid blocking region between the fluid inlet channel 1 and the fluid outlet channel 2.

The fluid turbine of the present invention is also referred to as a “tangential fluid turbine” due to the tangential direction of the fluid flowing in the fluid circulation channel 11, typically present between the rotor and the stator.

The tangential fluid turbine according to the present invention is a turbine having particular structural properties leading to high performance efficiency. The fluid tangentially entering the fluid circulation channel 11 through the fluid inlet channel 1 at a flow velocity vₑᵢₙ exerts pressure on the front side of the blade(s) 5, 5′ present in the fluid circulation channel and thus brings about a rotation of the rotor 13, to which the blades 5, 5′ are attached, in the flow direction of the fluid in the fluid circulation channel 11. The fluid exits the turbine tangentially at a flow velocity vₐᵤₛ through the fluid outlet channel 2 after circulating in the fluid circulation channel 11.

The fluid circulates at a constant moment and has a tangential effect, that is, the flow direction of the fluid is tangential to the circular arc of the fluid circulation channel 11 at every point in the fluid circulation channel 11, wherein the pressure of the fluid in the fluid inlet channel pₑᵢₙ is nearly equal to that of the fluid in the fluid outlet channel pₐᵤₛ.

The tangential effect is present at every point during the entire circulation of the fluid in the fluid circulation channel 11, so that a maximum efficiency is achieved.

Tangential fluid turbines may be used, for example, to transmit force due to the pressure of liquids or gases from one system to a different one at different spacing and angles, for example from one turbine to a further turbine.

The turbine efficiency varies depending on the design and friction. As a modern turbine having over 90% efficiency, for example, said turbine may also be used in various vehicles, because the turbine may be combined with an internal combustion engine or electric motor. The turbine may also, however, be used in hydropower plants.

A fluid blocking device 6 is typically present between the fluid inlet channel 1 and the fluid outlet channel 2 and at least partially, preferably completely prevents the fluid present in the region of the fluid outlet channel 2 from entering the fluid inlet channel 1. The fluid circulating in the turbine is thus prevented from causing a “short circuit”. The region in which the fluid blocking device 6 is present is also referred to as the “fluid blocking region”.

Preferably, the fluid outlet channel 11 is part of an annular, concentric full channel formed about the rotor 13, comprising openings for the fluid inlet channel 1 and the fluid outlet channel 2, and comprising a fluid blocking region within the full channel having a fluid blocking device 6 between the fluid inlet channel 1 and the fluid outlet channel 2.

The fluid blocking device 6 may be designed, for example, such that said device is attached to the inner wall of the stator or is part of the same.

Furthermore, the fluid blocking device 6 may be designed, for example, so as to be flexible and such that a blade deflects when said blade 5, 5′ passes through the region in which the fluid blocking device 6 is present (the fluid blocking region), or such that said fluid blocking device can be received in the stator when a blade 5, 5′ passes through the fluid blocking region.

Preferably, the blade(s) 5, 5′ mounted on the rotor 13 are designed so as to be able to be received in the rotor 13 when passing through the fluid blocking region. This may be done, for example, in that the blade(s) 5, 5′ are designed to be retractable or foldable into the rotor 13.

In the present preferred embodiment of the fluid turbine, the fluid blocking device 6 is typically rigid in design and attached to the stator or part of the stator.

Preferably, the fluid turbine is configured such that the blades 5, 5′ are automatically received in the rotor 13 when passing through the fluid blocking region, that is, without further means, such as means for bringing about adhesion of the blades on the rotor by means of magnetic force, for example.

Preferably, the blade(s) 5, 5′ can be received in the rotor, for example in a foldable manner, such that the outer diameter of the rotor in the region of the received blade(s) is equal to or less than the outer diameter of the rotor outside of the receiving region(s). The blade(s) 5, 5′ in the present embodiment are thus completely received in or folded into the rotor.

Further preferably, the blades 5, 5′ are foldable in design, so that said blades can be folded into the rotor 13 in the fluid blocking region and can be folded out in the region of the fluid circulation channel 11, that is, in the angular range of the turbine in which fluid circulation occurs, wherein pressure is exerted by the fluid flowing through the fluid circulation channel 11 on the front wide side (front side) of the blade(s) 5, 5′ in the state when folded out and thus the rotor 13 is induced to rotate.

The foldable design may be implemented, for example, by means of a hinge 3 mounted on the rotor or on the respective blade.

Preferably, recesses 18 for receiving the blades 5, 5′ in the received state, preferably when folded in, are present in the outer region of the rotor 13.

Preferably, the blades 5, 5′ are designed so as to be completely present in the fluid channel when extended or folded out. Thus preferably no recesses for receiving partial receiving of the blades 5, 5′ are present in the rotor 13

In the preferred embodiment of the turbine, in which the blades can be received in the rotor, preferably folded in, the blades may perform a double function during the rotary motion of the rotor, namely as actually fluidically impacted blades in the fluid circulation channel (when extended or folded out) or as a valve (when received or folded in).

Further preferably, the fluid blocking device 6 in the preferred embodiment of the turbine, in which the blades 5, 5′ can be received in, preferably folded into, the rotor 13, is implemented such that said device (also) brings about the receiving of the blade(s) 5, 5′ in the rotor, for example the folding in of the blades 5, 5′ into the corresponding recess 18.

This may be done, for example, in that the fluid blocking device 6 is implemented so as to continuously further limit the space available to the blade 5 in the extended state as the rotor 13 rotates, until full folding in is brought about at least in the region in which the fluid blocking device 6 maximally, preferably completely, prevents the passage of fluid.

The fluid blocking device 6 may comprise a compression bar having a compression spring 17 for supporting the function of the fluid blocking device 6 and serving to block the passage of the fluid between the fluid blocking device 6 and the opposite rotor 13.

During rotation of the rotor 13, the compression bar 17 can be pushed back by the blades 5, 5′, that is, in the direction of the blocking device 6, until the blades 5, 5′ have passed through the region of the compression bar 17, wherein the compression bar 17 then returns to the starting position thereof due to the effect of the compression spring.

After the rotor 13 having (one of) the received, preferably folded in, blades 5′ has passed through the fluid blocking region, the blade(s) 5 is (are) extended or folded out again in the fluid inlet region, for example before or at the inlet into the fluid circulation channel 11. This may be brought about, for example, by means of a spring mechanism or by the fluid flow.

Preferably, in the tangential fluid turbine according to the invention, the fluid circulation channel 11 is implemented such that the central angle of the circular arc underlying the shape of the fluid circulation channel 11 between the fluid inlet channel 1 and the fluid outlet channel 2 is at least 30°, further preferably at least 60°, further preferably at least 90°, further preferably at least 120°, and still further preferably at least 160°. Said central angle is typically 180°.

Preferably, the turbine is configured so that the angle between the direction of the fluid entering the turbine and the fluid exiting the turbine is at least 30°, further preferably at least 60°, further preferably at least 90°, further preferably at least 120°, and still further preferably at least 160°. Said angle is typically 180°.

Preferably, the tangential fluid turbine according to the invention is configured so that the blades 5, 5′ are fully extended or folded out in the entire circular arc underlying the shape of the fluid circulation channel 11 between the fluid inlet channel 1 and fluid outlet channel.

For example, in the embodiments wherein the fluid circulation channel 11 is implemented such that the central angle of the circular arc underlying the shape of the fluid circulation channel 11 between the fluid inlet channel 1 and the fluid outlet channel 2 is at least 30°, further preferably at least 60°, further preferably at least 90°, further preferably at least 120°, and still further preferably at least 160°, and typically 180°, the blades 5, 5′ are fully extended or folded out when passing through said angle ranges in the corresponding embodiment.

Typically, the turbine is configured so that the angle between the direction of the fluid entering the turbine and the fluid exiting the turbine corresponds to the central angle of the circular arc underlying the shape of the fluid circulation channel 11 between the fluid inlet channel 1 and the fluid outlet channel 2.

Typically, the fluid circulation channel 11 is disposed parallel to a plane perpendicular to the axis of the shaft 12.

Preferably, the turbine according to the invention comprises two blades 5, 5′ mounted on the rotor 13 and further preferably disposed spaced apart from each other by 180° relative to the circular shape of the rotor. Thus, in the present embodiment, exactly two blades 5, 5′ are present on the rotor. Typically, the wide sides, at least the front wide side (front side), of the blade(s) 5, 5′ are disposed perpendicular to the flow direction of the fluid in the circulation channel when extended, e.g., folded out.

Furthermore, the longitudinal direction(s) of the blade(s) 5, 5′ is/are typically disposed radially to the turbine shaft 12 when extended, e.g., folded out.

Typically, the turbine housing in which the rotor 13 is rotatably supported is part of the stator.

Preferably, the turbine comprises a control valve 14 at the fluid inlet channel 1, by means of which the amount of fluid entering the turbine can be controlled, for example reduced or increased.

When the amount of fluid entering remains the same, the torque of the rotor 13 remains unchanged, while an increase or decrease in the amount of fluid causes an increase or decrease, respectively, in the torque of the rotor 13.

The fluid circulation channel 11 is typically bounded or formed (in part) by the outer circumference of the rotor and the housing 9 forming the stator of the turbine.

Typically, the area of the front wide side, that is, the front side impinged on by the fluid, of the blades 5, 5′ in the fluid circulation channel 11 projected onto a radial cross section of the fluid circulation channel 11 is at least 90%, preferably at least 95%, and most preferably 100% of the radial cross-sectional area of the fluid circulation channel 11.

In the tangential fluid turbine according to the present invention, a gas such as air, a compressed gas, a gas in a supercritical state, or a liquid such as oil or water may be used as the fluid, for example. Preferably, a liquid is used as the fluid.

The present invention further relates to a method for operating a tangential fluid turbine in any one of the embodiments described here.

The present invention further relates to the use of a tangential fluid turbine in any one of the embodiments described here in a motor vehicle, ship, or power plant.

### EXAMPLE

An embodiment of the tangential fluid turbine according to the invention, preferably for a liquid as the fluid, is described in more detail below with reference to the figures.

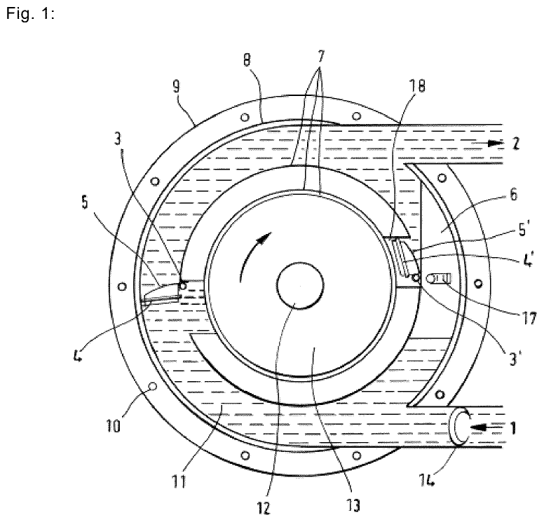

FIG. 1 shows a horizontal cross section of an embodiment of the fluid turbine according to the invention.

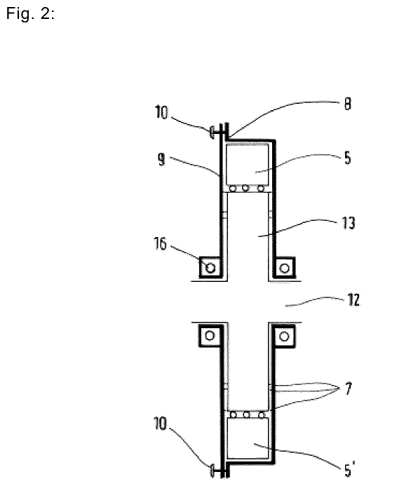

FIG. 2 shows a side cross section of the embodiment of the fluid turbine according to the invention shown in FIG. 1.

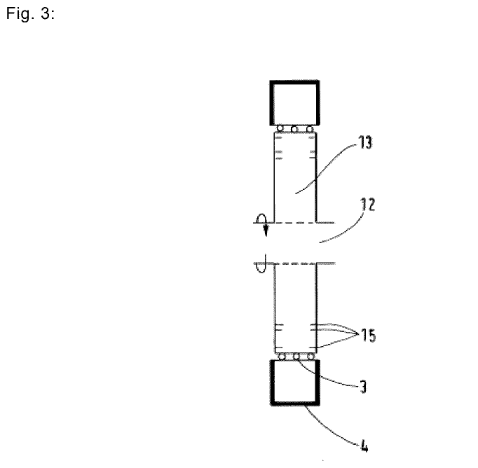

FIG. 3 shows a partial side cross section of the embodiment of the fluid turbine according to the invention shown in FIG. 1.

FIG. 1 shows a cross section of an embodiment of the tangential fluid turbine according to the present invention. The turbine comprises a shaft 12, a concentric rotor 13 connected to the shaft 12, two foldable blades 5, 5′ mounted on the rotor 13 and disposed spaced apart from each other by 180° relative to the circular shape of the rotor 13, a fluid inlet channel 1, a fluid outlet channel 2, and a circular arc-shaped fluid circulation channel 11 concentric to the shaft 12 and connecting the fluid inlet channel 1 and the fluid outlet channel 2.

The fluid outlet channel 11 is part of an annular, concentric full channel formed about the rotor 13, comprising openings for the fluid inlet channel 1 and the fluid outlet channel 2, and comprising a fluid blocking region having a fluid blocking device 6 between the fluid inlet channel 1 and the fluid outlet channel 2. The central angle of the circular arc underlying the shape of the fluid circulation channel 11 is 180° between the fluid inlet channel 1 and the fluid outlet channel 2, and the fluid circulation channel 11 is disposed parallel to a plane perpendicular to the axis of the shaft 12. The fluid circulation channel 11 is formed by the outer circumference of the rotor and a part of the housing 9 forming the stator of the turbine, namely a part of the inner wall of the housing, as can also be seen in FIG. 2. Furthermore, a seal 8 is present on the inner wall of the housing.

Fluid flows through the fluid inlet channel 1 in a direction tangential to a circle concentric to the shaft 12 into the fluid circulation channel 11 and exist the fluid circulation channel 11 through the fluid outlet channel 2 in a direction tangential to said circle.

The rotor 13 is implemented in a disc shape about the shaft 12 and the inner region thereof contacts the shaft 12 and is fixedly connected thereto.

The turbine comprises a control valve 14 at the fluid inlet channel 1, by means of which the amount of fluid entering the turbine can be controlled.

The foldable blades 5, 5′ are attached to the rotor 13 by means of a hinge 3, so that the wide sides thereof, particularly the impinged front sides, are disposed perpendicular to the flow direction of the fluid in the circulation channel when folded out. The longitudinal directions of the blades 5, 5′ are disposed radially to the turbine shaft 12 when folded out.

The fluid blocking device 6 is rigid in design, attached to the inner wall of the stator, and brings about the condition that fluid present in the region of the fluid outlet channel 2 cannot return to the fluid inlet channel 1. The fluid circulating in the turbine is thus prevented from causing a “short circuit”.

The blades 5, 5′ mounted on the rotor 13 are received in the rotor 13 when passing through the fluid blocking region. This is done such that the blades 5, 5′ are folded into the rotor 13 by means of the fluid blocking device 6 when passing through the fluid blocking region. Said device continuously constricts the space available to the blades 5, 5′ outside of the rotor when passing through, so that ultimately the full folding in of the blades 5, 5′ into the rotor 13 is brought about.

A compression bar having a spring 17 and being part of the fluid blocking device 6 and being pressed back into the starting position thereof by the effect of the compression spring after the blades 5, 5′ have passed through the region of the compression bar 17 further prevents fluid from passing between the fluid blocking device 6 and the opposite rotor 13 and thus from returning to the region of the fluid inlet channel 1.

Recesses 18 are present in the principally annular outer region of the rotor 13 for receiving the folded-in blades 5′, into which recesses the blades 5, 5′ can be received when folded in such that the outer diameter of the rotor in the region of the received blade(s) having the received blades 5′ is maximally equal to the outer diameter of the rotor outside of the receiving regions. Furthermore, compression rings 7 are present at the outer circumferential region of the rotor 13 and in the region between the outer and inner region of the rotor 13.

Furthermore, the fluid blocking device 6 is implemented so that a region thereof seals tightly with the outer region of the rotor in a region in the direction of the blades 5, 5′ passing through wherein said blades are fully folded in, so that no fluid can penetrate. Said region of the fluid blocking device 6 ends before the fluid inlet channel 1.

During operation of the turbine, fluid flows into the fluid circulation channel 11 through the fluid inlet channel 1 in a tangential direction, and the amount of fluid is controlled by the control valve 14. Here the fluid impinges on the front wide side of the folded-out blades 5, and consequently said blades are induced to motion in the fluid circulation channel 11 in the direction of flow of the fluid, whereby the rotary motion of the rotor is brought about.

The fluid then exits the turbine through the fluid outlet channel 2 in a tangential direction. The rotary motion of the rotor 13 causes the same to be guided through the fluid blocking region, where the fluid blocking device 6 brings about the folding in of the blades 5, 5′ into the outer region of the rotor 13 and prevents the return flow or passage of fluid to the fluid inlet region 1.

After the rotor 13 has passed through the fluid blocking region, the blades 5, 5′ are folded out again by the effect of the inflowing fluid, so that said blades are again fully folded out no later than in the fluid circulation channel 11.

As can also be seen in FIG. 2, blade rings 4 are present in the outer region of the blades 5, 5′ and seal off the blades against the inner walls of the fluid circulation channel 11, so that the area of the front wide side of the blades 5, 5′, that is, of the front side impinged by the fluid, projected onto a radial cross section of the fluid circulation channel 11 is 100% of the radial cross-sectional area of the fluid circulation channel 11, and thus the flow of the fluid is maximally utilized.

Furthermore, FIGS. 2 and 3 show cross sections of the turbine in the plane of the shaft axis. FIG. 2 shows the turbine housing 9 as the stator, wherein the upper part thereof bounds the fluid circulation channel 11. Furthermore, the bearings 16 of the rotor 13 are shown as part of the stator on which the axis of the shaft 12 is supported. The different parts of the turbine housing 9 are connected to each other by connections 10, for example screw connections. The blades 5 are shown in the folded-out state, and FIG. 2 also shows the compression rings 7 present on the rotor.

Furthermore, FIG. 3 shows the compression ring channels 15 present on the rotor.

### Reference List

1 Fluid inlet channel
2 Fluid outlet channel
3. Hinge
4. Blade ring
5 Folding blade, folded out
5′ Foldable blade, folded in
6 Fluid blocking device
7 Rotor compression rings
8 Seal
9 Turbine housing
10 Connections to stator
11 Fluid circulation channel
12 Shaft
13 Rotor
14 Fluid inlet control valve
15 Channel compression rings
16 Rotor bearing
17 Compression bar with spring
18 Recess in outer region of the rotor for receiving the blade 5′ when folded in

1. A tangential fluid turbine comprising a shaft, a concentric rotor connected to the shaft, blades mounted on the rotor, a fluid inlet channel, a fluid outlet channel, and a circular arc-shaped fluid circulation channel concentric to the shaft and connecting the fluid inlet channel and the fluid outlet channel, the blades of the rotor being displaced therein by the fluid flowing through the fluid circulation channel, whereby the rotary motion of the rotor is brought about, wherein the fluid inlet channel is designed such that the fluid enters the fluid circulation channel in a direction tangential to a circle concentric to the shaft and the fluid outlet channel is designed such that the fluid exits the fluid circulation channel in a direction tangential to a circle concentric to the shaft.

2. The tangential fluid turbine according to claim 1, wherein a fluid blocking device is present in a fluid blocking region between the fluid inlet channel and the fluid outlet channel.

3. The tangential fluid turbine according to claim 1, wherein the blades are designed so as to be able to be received in the rotor when passing through the fluid blocking region.

4. The tangential fluid turbine according to claim 1, wherein the blades are foldable in design.

5. The tangential fluid turbine according to claim 4, wherein recesses for receiving the blades when folded in are present in the outer region of the rotor.

6. The tangential fluid turbine according to claim 1, wherein the fluid blocking device is implemented so as to bring about the receiving of the blade(s) in the rotor.

7. The tangential fluid turbine according to claim 1, wherein the central angle of the circular arc underlying the shape of the fluid circulation channel between the fluid inlet channel and the fluid outlet channel is at least 30°, further preferably at least 60°, further preferably at least 90°, further preferably at least 120°, and still further preferably at least 160°.

8. The tangential fluid turbine according to claim 1, wherein the fluid circulation channel is disposed parallel to a plane perpendicular to the axis of the shaft.

9. The tangential fluid turbine according to claim 1, wherein said turbine comprises two blades mounted on the rotor and preferably disposed spaced apart from each other by 180° relative to the circular shape of the rotor.

10. The tangential fluid turbine according to claim 1, wherein the fluid circulation channel is formed by the outer circumference of the rotor and the inner side of the housing forming the stator of the turbine.

11. The tangential fluid turbine according to claim 1, wherein the front surface of the blades in the fluid circulation channel projected onto a radial cross section of the fluid circulation channel is at least 90%, preferably at least 95%, and most preferably 100% of the radial cross-sectional area of the fluid circulation channel.

12. The tangential fluid turbine according to claim 1, wherein a liquid is used as the fluid.

13. The tangential fluid turbine according to claim 1, wherein said turbine comprises a control valve at the fluid inlet channel, by means of which the amount of fluid entering the turbine can be controlled.

14. A method for operating a tangential fluid turbine according to claim 1.

15. The use of a tangential fluid turbine according to claim 1 in a motor vehicle, ship, or power plant.

16. A motor vehicle, ship, or power plant, wherein said motor vehicle, ship, or power plant comprises a tangential fluid turbine according claim 1.
